(19) United States
(12) Patent Application Publication
(10) Pub. No.: US 2020/0185699 A1
(43) Pub. Date: Jun. 11, 2020

(54) METHOD FOR PRODUCING SOLID ELECTROLYTE AND ELECTRODE FOR ALL-SOLID STATE BATTERIES

(71) Applicant: TOYOTA MOTOR EUROPE, Brussels (BE)

(72) Inventors: Yuki KATOH, Brussels (BE); Geoffroy HAUTIER, Brussels (BE); Anna MIGLIO, Louvain-La-Neuve (BE)

(73) Assignee: TOYOTA MOTOR EUROPE, Brussels (BE)

(21) Appl. No.: 16/635,400

(22) PCT Filed: Aug. 4, 2017
(86) PCT No.: PCT/EP2017/069856

§ 371 Date: Jan. 30, 2020

(51) Int. Cl. H01M 4/04; H01M 4/1397

(52) U.S. Cl. CPC H01M 4/0471; H01M 4/1397; H01M 4/048

(57) ABSTRACT

A method (100) for producing a sintered component being a solid electrolyte and/or an electrode including sulfur for an all-solid state battery, the method including mixing powders (102) so as to obtain a powder mixture, at least one of the powders comprising sulfur, pressing (106) a component with the powder mixture and sintering (108) the component under a partial pressure of sulfur comprised between 150 Pa and 0.2 MPa so as to obtain a sintered component comprising sulfur, the sintered component exhibiting the peaks in positions of 2θ=15.08° (±0.50°), 15.28° (±0.50°), 15.92° (±0.50°), 17.5° (±0.50°), 18.24° (±0.50°), 20.30° (±0.50°, 23.44° (±0.50°), 24.48° (±0.50°), and 26.66° (±0.50°) in a X-ray diffraction measurement using CuKα line.

### FIELD OF THE DISCLOSURE

The present disclosure is related to all-solid state batteries, and more particularly to solid state batteries comprising a solid electrolyte and/or an electrode comprising sulfur.

### BACKGROUND OF THE DISCLOSURE

All-solid state batteries offer the possibility of having a battery pack with high energy density.

Different materials are studied for solid electrolyte and/or electrode for all-solid state batteries. Of particular interest are materials comprising sulfur and exhibiting peaks in positions of 2θ=15.08° (±0.50°), 15.28° (±0.50°), 15.92° (±0.50°), 17.5° (±0.50°), 18.24° (±0.50°), 20.30° (±0.50°), 23.44° (±0.50°), 24.48° (±0.50°), and 26.66° (±0.50°) in a X-ray diffraction measurement using CuKα line. These materials generally exhibit good lithium ionic conductivity.

However, increase of the lithium ionic conductivity of such materials is still required for application as solid electrolyte and/or electrode.

### SUMMARY OF THE DISCLOSURE

Therefore, according to embodiments of the present disclosure, a method for producing a sintered component being a solid electrolyte and/or an electrode comprising sulfur for an all-solid state battery is provided. The method comprises:
mixing powders so as to obtain a powder mixture, at least one of the powders comprising sulfur;
pressing a component with the powder mixture; and
sintering the component under a partial pressure of sulfur comprised between 200 Pa and 0.2 MPa so as to obtain a sintered component comprising sulfur;

wherein the sintered component exhibits the peaks in positions of 2θ=15.08° (±0.50°), 15.28° (±0.50°), 15.92° (±0.50°), 17.5° (±0.50°), 18.24° (±0.50°), 20.30° (±0.50°), 23.44° (±0.50°), 24.48° (±0.50°), and 26.66° (±0.50°) in a X-ray diffraction measurement using CuKα line.

Sintered components, i.e., solid electrolytes and/or electrodes exhibiting peaks in positions of 2θ=15.08° (±0.50°), 15.28° (±0.50°), 15.92° (±0.50°), 17.5° (±0.50°), 18.24° (±0.50°), 20.30° (±0.50°), 23.44° (±0.50°), 24.48° (±0.50° ), and 26.66° (±0.50° ) in a X-ray diffraction measurement using CuKα line, generally exhibit good lithium ionic conductivity.

By providing such a method, it is possible to increase the lithium ionic conductivity through the solid electrolyte and/or the electrode. Indeed, by sintering the component under partial pressure of sulfur comprised between 200 Pa (Pascal) and 0.2 MPa, evaporation of the sulfur during sintering is limited and the bulk density of the sintered component is increased. Therefore, the porosity of the sintered component is reduced and the lithium ionic conductivity of the sintered component is increased, i.e., the lithium ionic conductivity of the solid electrolyte and/or of the electrode.

In some embodiments, the sintered component comprises XTi₂(PS₄)₃ and/or XZr₂(PS₄)₃, X being lithium (Li), sodium (Na) or silver (Ag).

In some embodiments, the partial pressure of sulfur is obtained by evaporating solid sulfur.

In some embodiments, the component is placed in a container and sealed under Argon at a pressure equal to or smaller than 100 Pa, preferably equal to or smaller than 50 Pa.

In some embodiments, the partial pressure of sulfur is obtained from a sulfur containing gas.

The sulfur containing gas may be a gas such as hydrogen sulfide, carbon sulfide or phosphorous sulfide.

In some embodiments, the method comprises a step of amorphasizing the powder mixture so as to obtain an amorphasized powder mixture.

In some embodiments, sintering comprises a sintering plateau temperature equal to or smaller than 500° C., preferably equal to or smaller than 400° C.

The powder mixture being amorphasized, the powder mixture is more reactive and sintering of the powder mixture may be obtained at temperature equal to or smaller than 500° C.

In some embodiments, sintering comprises a sintering plateau time equal to or smaller than 20 hours, preferably equal to or smaller than 10 hours.

The powder mixture being amorphasized, the powder mixture is more reactive and sintering of the powder mixture may be obtained with sintering plateau time equal to or smaller than 20 hours, preferably equal to or smaller than 10 hours.

In some embodiments, sintering is a two-step sintering, a first sintering step under a partial pressure of sulfur comprised between 200 Pa and 0.2 MPa so as to obtain an intermediate product, the intermediate product being grinded so as to obtain a sintered powder, the sintered powder being pressed and sintered during a second sintering step under a partial pressure of sulfur comprised between 200 Pa and 0.2 MPa.

In some embodiments, the component is pressed at a pressure equal to or greater than 25 MPa, preferably equal to or greater than 50 MPa, more preferably equal to or greater than 75 MPa, and equal to or smaller than 500 MPa, preferably equal to or smaller than 400 MPa, more preferably equal to or smaller than 300 MPa.

It is intended that combinations of the above-described elements and those within the specification may be made, except where otherwise contradictory.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, serve to explain the principles thereof.

### BRIEF DESCRIPTION OF THE DRAWINGS

FIG. 1 shows a first flow chart of the method according to embodiments of the present disclosure;

FIG. 2 shows a second flow chart of the method according to embodiments of the present disclosure;

FIG. 3 shows a X-ray diffraction spectrum of a sample according to the present disclosure;

FIG. 4 shows a X-ray diffraction spectrum of a comparative sample.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

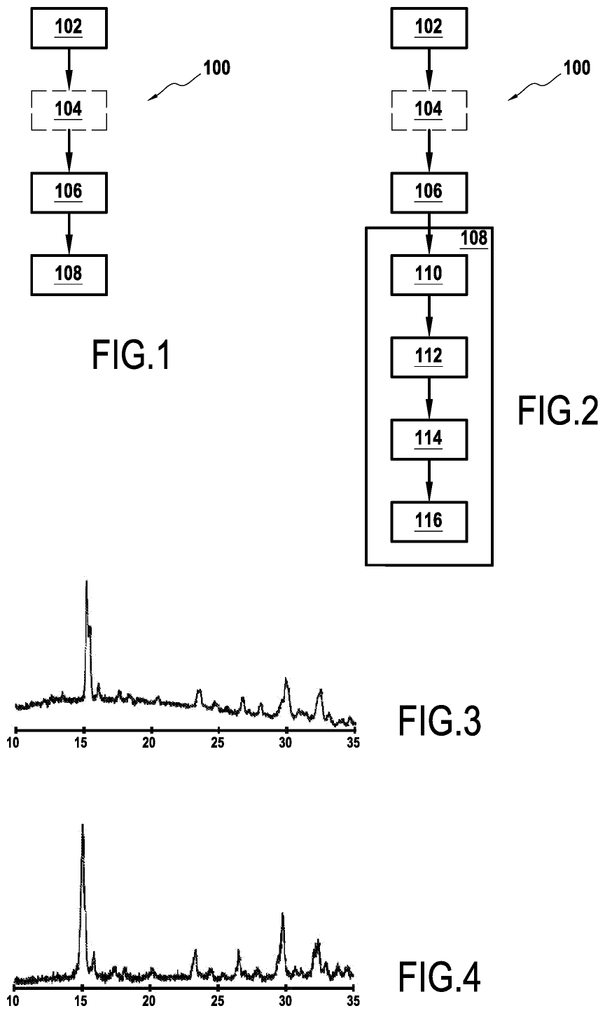

FIG. 1 shows a representation of a first flow chart of the method according to embodiments of the present disclosure.

Sample 1 is a sample according to the present disclosure and Sample 2 is a comparative sample.

Sample 1 and Sample 2 are both LiTi₂(PS₄)₃ solid electrolyte or electrode.

Every experiment are done under the argon or under vacuum or under sulfur atmosphere so as never be in contact with air.

A method 100 for producing a solid electrolyte and/or an electrode comprising sulfur for an all-solid state battery will be described in reference to FIG. 1, taking Sample 1.

In step 102, 0.0396 g (gram) of Li₂S, 0.5745 g of P₂S₅ and 0.3859 g of TiS₂ are mixed together so as to obtain a powder mixture. Li₂S (99%, lithium sulphide, Sigma-Aldrich®), P₂S₅ (98%, phosphorous pentasulfide, Sigma-Aldrich®) and TiS₂ (99,9%, titanium disulphide, Sigma-Aldrich®) are powders having a degree of purity equal to or greater than 99 mass %.

In step 104, which is not a mandatory step, the powder mixture is amorphasized in a planetary milling equipment (Fritsch, P7). The powder mixture was disposed in a zirconium pot of 45 mL (millilitre) content with 18 zirconium balls having a diameter of 10 mm (millimetre) under Argon. The powder mixture was amorphasized for 40 hours at 370 rpm (round per minute) so as to obtain amorphasized powder mixture.

In step 106, the amorphasized powder mixture is pressed at a pressure equal to or greater than 25 MPa, preferably equal to or greater than 50 MPa, more preferably equal to or greater than 75 MPa, and equal to or smaller than 500 MPa, preferably equal to or smaller than 400 MPa, more preferably equal to or smaller than 300 MPa.

For example 100 mg of the amorphasized powder mixture is pressed at 200 MPa so as to form a component.

In step 108, the component is sintered under a partial pressure of sulfur comprised between 150 Pa and 0.2 MPa so as to obtain a sintered component comprising sulfur.

For example, the 100 mg component is put into a glass tube with 5 mg flakes of sulfur from Sigma-Aldrich® (99.99%) and the glass tube is sealed under Argon under very low pressure, for example 30 Pa. The component is sintered at a plateau temperature of 400° C. (degree Celsius) for a plateau temperature time of 8 hours so as to obtain a sintered component comprising sulfur. Upon heating, the solid flakes of sulfur allow for a partial pressure of sulfur to be comprised between 200 Pa and 0.2 MPa in the sealed glass tube.

Alternatively, the partial pressure of sulfur comprised between 150 Pa and 0.2 MPa may be obtained from a sulfur containing gas such as hydrogen sulfide (H₂S), carbon disulfide (CS₂) or phosphorous sulfide (PₓS_{y}, e.g. P₄S₃, P₂S₃ or P₂S₅) in a closed container, such as a sealed glass tube or in an open container with gas flush.

As shown in FIG. 2, sintering step 108 may be a two-step sintering step. Sintering step 108 may comprise a first sintering step 110 under a partial pressure of sulfur comprised between 200 Pa and 0.2 MPa so as to obtain an intermediate product. The intermediate product is then grinded (step 112) so as to obtain a sintered powder, the sintered powder being pressed (step 114) and sintered during a second sintering step (116) under a partial pressure of sulfur comprised between 200 Pa and 0.2 MPa.

The pressure used in steps 106 and 114 may be different. The pressure used in steps 106 and 114 may be equal. However, the pressure in both steps 106 and 114 is equal to or greater than 25 MPa, preferably equal to or greater than 50 MPa, more preferably equal to or greater than 75 MPa, and equal to or smaller than 500 MPa, preferably equal to or smaller than 400 MPa, more preferably equal to or smaller than 300 MPa.

For example, the pressure in step 106 may be equal to 200 MPa and the pressure in step 114 may be equal to 100 MPa.

The sintering parameter in steps 110 and 116 may be different. The sintering parameter in steps 110 and 116 may be equal.

For example, in both steps 110 and 116, the temperature plateau may be equal to 400° C. and the temperature plateau time may be equal to 8 hours, the sintered component of Sample 1 having therefore been sintered at 400° C. for 16 hours under a partial pressure of sulfur comprised between 200 Pa and 0.2 MPa.

Sample 1 is obtained with the method of FIG. 2, with a two-step sintering.

The method for producing Sample 2 is similar to the method for producing Sample 1, except that the two-step sintering step is not carried out under a partial pressure of sulfur comprised between 200 Pa and 0.2 MPa but under a partial pressure of sulfur smaller than 150 Pa.

The pressed component is sintered at 400° C. for 8 hours under a partial pressure of sulfur or smaller than 150 Pa, for example by sealing the component of Sample 2 in a glass tube under Argon under very low pressure, for example 30 Pa without flakes of sulfur. The sintered component of Sample 2 has therefore been sintered at 400° C. for 16 hours under a partial pressure of sulfur smaller than 150 MPa.

FIGS. 3 and 4 show X-ray diffraction spectra respectively of Sample 1 and Sample 2. As may be seen on FIGS. 3 and 4, both Sample 1 and Sample 2 exhibit the peaks in positions of 2θ=15.08° (±0.50°), 15.28° (±0.50°), 15.92° (±0.50°), 17.5° (±0.50°), 18.24° (±0.50°), 20.30° (±0.50°), 23.44° (±0.50°), 24.48° (±0.50°), and 26.66° (±0.50°) in a X-ray diffraction measurement using CuKα line.

However, Sample 1 has a bulk density of 1.65 g/cm³ whereas Sample 2 has a bulk density of 1.59 g/cm³.

Sample 1 and Sample 2 were each sandwiched between two SUS current collectors (Stainless steel, SUS301). Impedance of both Sample 1 and Sample 2 was measured using an impedance gain-phase analyser manufactured by Biologic. VMP3 manufactured by Biologic was used for the measurement as Frequency Response Analyzer (FRA). The measurements were started from a high-frequency range with an alternative voltage of 10 mV (millivolt) and a frequency range between 1 Hz (hertz) to 1 MHz.

The ionic conductivity of Sample 1 is equal to 6.3 10⁻⁴ S/cm (Siemens per centimetre) whereas the ionic conductivity of Sample 2 is equal to 3.5 10⁻⁴ S/cm.

Thus, by sintering under a partial pressure of sulfur comprised between 200 Pa and 0.2 MPa, the ionic conductivity of the sintered component, i.e., of the solid electrolyte and/or of the electrode, has been increased significantly.

Although Sample 1 1 was obtained with the method of FIG. 2, with a two-step sintering, similar results may be obtained with a single sintering step 108.

When the powder mixture is not amorphasized, i.e., when step 104 is not carried out, in step 106, the powder mixture is pressed at a pressure equal to or greater than 25 MPa, preferably equal to or greater than 50 MPa, more preferably equal to or greater than 75 MPa, and equal to or smaller than 500 MPa, preferably equal to or smaller than 400 MPa, more preferably equal to or smaller than 300 MPa.

For example 100 mg of the powder mixture is pressed at 200 MPa so as to form a component.

In step 108, the component is sintered under a partial pressure of sulfur comprised between 200 Pa and 0.2 MPa so as to obtain a sintered component comprising sulfur.

For example, the 100 mg component is put into a glass tube with 5 mg flakes of sulfur from Sigma-Aldrich® (99.99%) and the glass tube is sealed under Argon under very low pressure, for example 30 Pa. The component is sintered at a plateau temperature above 500° C. (degree Celsius), for example 750° C. for a plateau temperature time of 10 hours so as to obtain a sintered component comprising sulfur.

Alternatively, the partial pressure of sulfur comprised between 200 Pa and 0.2 MPa may be obtained from a sulfur containing gas such as hydrogen sulfide (H₂S), carbon disulfide (CS₂) or phosphorous sulfide (PₓS_{y}, e.g. P₄S₃, P₂S₃ or P₂S₅) in a closed container, such as a sealed glass tube or in an open container with gas flush.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A method for producing a sintered component being a solid electrolyte and/or an electrode comprising sulfur for an all-solid state battery, the method comprising:
mixing powders so as to obtain a powder mixture, at least one of the powders comprising sulfur;
pressing a component with the powder mixture; and
sintering the component under a partial pressure of sulfur comprised between 200 Pa and 0.2 MPa so as to obtain a sintered component comprising sulfur;
wherein the sintered component exhibits the peaks in positions of 2θ=15.08° (±0.50°), 15.28° (±0.50°), 15.92° (±0.50°), 17.5° (±0.50°), 18.24° (±0.50°), 20.30° (±0.50°), 23.44° (±0.50°), 24.48° (±0.50°), and 26.66° (±0.50°) in a X-ray diffraction measurement using CuKα line.

2. The method according to claim 1, wherein the sintered component comprises XTi₂(PS₄)₃ and/or XZr₂(PS₄)_{3,}X being lithium (Li), sodium (Na) or silver (Ag).

3. The method according to claim 1, wherein the partial pressure of sulfur is obtained by evaporating solid sulfur.

4. The method according to claim 3, wherein the component is placed in a container and sealed under Argon at a pressure equal to or smaller than 100 Pa, preferably equal to or smaller than 50 Pa.

5. The method according to claim 1, wherein the partial pressure of sulfur is obtained from a sulfur containing gas.

6. The method according to claim 1, the method comprising a step of amorphasizing the powder mixture so as to obtain an amorphasized powder mixture.

7. The method according to claim 6, wherein sintering comprises a sintering plateau temperature equal to or smaller than 500° C.

8. The method according to claim 6, wherein sintering comprises a sintering plateau time equal to or smaller than 20 hours.

9. The method according to claim 1, wherein sintering is a two-step sintering, a first sintering step under a partial pressure of sulfur comprised between 200 Pa and 0.2 MPa so as to obtain an intermediate product, the intermediate product being grinded so as to obtain a sintered powder, the sintered powder being pressed and sintered during a second sintering step under a partial pressure of sulfur comprised between 200 Pa and 0.2 MPa.

10. The method according to claim 1, wherein the component is pressed at a pressure equal to or greater than 25 MPa and equal to or smaller than 500 MPa.
